(19) United States
(12) Patent Application Publication
(10) Pub. No.: US 2018/0082129 A1
(43) Pub. Date: Mar. 22, 2018

(54) INFORMATION PROCESSING APPARATUS, DETECTION SYSTEM, AND INFORMATION PROCESSING METHOD

(71) Applicant: KABUSHIKI KAISHA TOSHIBA, Tokyo (JP)

(72) Inventors: Yuto YAMAJI, Kawasaki (JP); Tomoyuki SHIBATA, Kawasaki (JP); Tomoki WATANABE, Tokyo (JP)

(73) Assignee: KABUSHIKI KAISHA TOSHIBA, Tokyo (JP)

(21) Appl. No.: 15/445,666

(22) Filed: Feb. 28, 2017

(30) Foreign Application Priority Data
Sep. 16, 2016 (JP) 2016-181742

(51) Int. Cl. G06K 9/00; G06T 7/73; G06T 7/60

(52) U.S. Cl. CPC G06K 9/00771; G06T 7/60; G06T 7/73

(57) ABSTRACT

According to an embodiment, an information processing apparatus includes a memory and processing circuitry. The processing circuitry configured to acquire a captured image of an object on a first plane. The processing circuitry configured to detect a position and a size of the object in the captured image. The processing circuitry configured to determine, based on the position and the size of the object in the captured image, a mapping relation representing a relation between the position of the object in the captured image and a position of the object in a virtual plane that is the first plane when viewed from a predetermined direction. The processing circuitry configured to convert the position of the object in the captured image into the position of the object on the virtual plane, based on the mapping relation.

### CROSS-REFERENCE TO RELATED APPLICATIONS

This application is based upon and claims the benefit of priority from Japanese Patent Application No. 2016-181742, filed on Sep. 16, 2016; the entire contents of which are incorporated herein by reference.

### FIELD

Embodiments described herein relate generally to an information processing apparatus, a detection system, and an information processing method.

### BACKGROUND

Surveillance camera systems for monitoring persons passing through a passageway in a station, a floor of a building, and the like have been known. In such a surveillance camera system, an image capture device mounted on the ceiling or the like is used to capture an image of persons.

There is a demand for such a surveillance camera system to be capable of monitoring the positions and the number of persons, as well as being capable of displaying the captured image. To achieve this end, the surveillance camera system is required, to calculate the positions of the respective persons in a top view, from the image captured by the image capture device.

The image capture device used in the surveillance camera system, however, captures an image of persons at a predetermined angle of depression with respect to the floor, and therefore, it is difficult for the surveillance camera system to accurately calculate the position of each of the persons, from the image captured by the image capture device. Furthermore, when the image of the persons is captured at a predetermined angle of depression with respect to the floor, the persons are represented in different sizes depending on the distance from the image capture device. Therefore, the surveillance camera system needs to detect the persons in different sizes, which entails significant computational costs.

### BRIEF DESCRIPTION OF THE DRAWINGS

FIG. 1 is a schematic illustrating a detection system according to an embodiment;

FIG. 2 is a schematic illustrating a positional relation between a plane of movement on which objects move, and an image capture device;

FIG. 3 is a schematic illustrating a functional configuration of a processing circuit according to a first embodiment;

FIG. 4 is a schematic illustrating an example of a captured image including objects;

FIG. 5 is a schematic illustrating an example of the positions and the sizes of objects in a captured image;

FIG. 6 is a schematic illustrating a relation between the positions of objects and the angular fields of the objects in the captured image, and the like;

FIG. 7 is a schematic illustrating a relation between the coordinates and the sizes of objects in the captured image;

FIG. 8 is a schematic illustrating an exemplary functional configuration of a converter;

FIG. 9 is a schematic illustrating an example of an output image according the first embodiment;

FIG. 10 is a flowchart illustrating a sequence of a process performed in the detection system;

FIG. 11 is a schematic illustrating a functional configuration of a detector according to a second embodiment;

FIG. 12 is a schematic illustrating the detection sixes of objects to be detected by the detector;

FIG. 13 is a schematic illustrating an example of a captured image that indicates absent areas;

FIG. 14 is a schematic illustrating divided areas that are a plurality of divisions of a captured image;

FIG. 15 is a schematic illustrating an example of an output image appended with moving directions of respective objects;

FIG. 16 is a schematic illustrating an example of an output image appended with estimated non-existing areas;

FIG. 17 is a schematic illustrating an example of an output image appended with information on an object outside of a visual field;

FIG. 18 is a schematic illustrating an example of an output image appended with non-existable areas;

FIG. 19 is a schematic illustrating an example of an output image according to a fifth embodiment;

FIG. 20 is a schematic illustrating detection areas divided in such a manner that the sizes of detection areas become smaller toward an image capture device;

FIG. 21 is a schematic illustrating detection areas having their borders matched with the borders of non-existable areas;

FIG. 22 is a schematic illustrating an example of an output image in which the number of objects is indicated as a luminance;

FIG. 23 is a schematic illustrating a functional configuration of a processing circuit according to a sixth embodiment;

FIG. 24 is a schematic illustrating an example of an output image according to the sixth embodiment;

FIG. 25 is a schematic illustrating areas with overlapping visual fields, and areas not covered by any of the visual fields;

FIG. 26 is a schematic illustrating a functional configuration of a processing circuit according to a seventh embodiment;

FIG. 27 is a schematic illustrating an example of an output image according to the seventh embodiment; and

FIG. 28 is a schematic illustrating an example of an output image according to an eighth embodiment.

### DETAILED DESCRIPTION

According to an embodiment, an information processing apparatus includes a memory and processing circuitry. The processing circuitry configured to acquire a captured image of an object on a first plane. The processing circuitry configured to detect a position and a size of the object in the captured image. The processing circuitry configured to determine, based on the position and the size of the object in the captured image, a mapping relation representing a relation between the position of the object in the captured image and a position of the object in a virtual plane that is the first plane when viewed from a predetermined direction. The processing circuitry configured to convert the position of the object in the captured image into the position of the object on the virtual plane, based on the mapping relation.

A detection system 10 according to some embodiments will now be explained with reference to some drawings. In the embodiments described below, because parts assigned with the same reference numerals have substantially the same functions and operations, redundant explanations thereof are omitted as appropriate, except for the differences thereof.

### First Embodiment

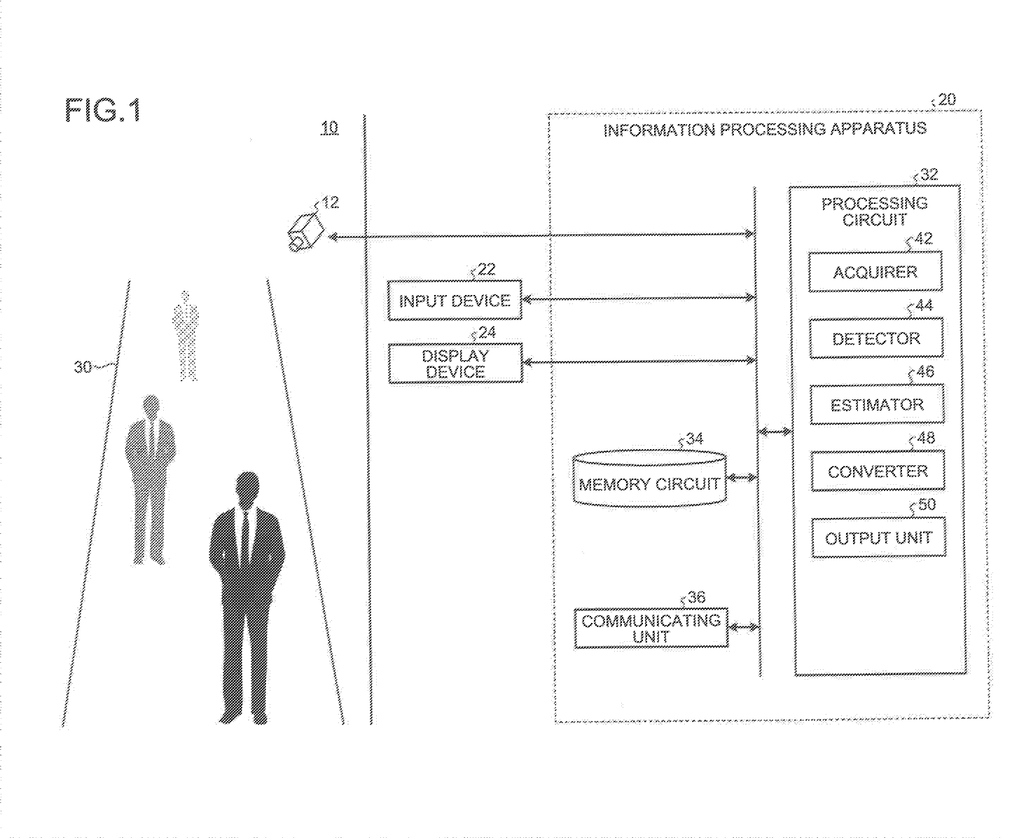

FIG. 1 is a schematic illustrating a detection system 10 according to an embodiment. The detection system 10 is aimed to accurately calculate the position of an object on a virtual surface of movement (a virtual plane such as a plane of movement represented in a top view and a plane of movement represented in a quarter view), representing a plane of movement (a first plane such as a floor) viewed from a predetermined direction, based on a captured image capturing the object moving on the plane of movement from a fixed viewpoint.

In the embodiment, the object is a person. The plane of movement is a floor, a road, or the like on which persons move. The object is however not limited to a person, and may be any other moving bodies, such as a vehicle.

The detection system 10 includes an image capture device 12, an information processing apparatus 20, an input device 22, and a display device 24.

The image capture device 12 is fixed to a position that allows the capturing of an image of a predetermined space in which objects move. The image capture device 12 captures the predetermined space from a fixed position. The image capture device 12 captures the images at a predetermined frame rate, and feeds the images acquired by the capturing to the information processing apparatus 20. The image captured by the image capture device 12 may be images of various types, such as visible-light images and infrared images.

The information processing apparatus 20 is a specialized or general-purpose computer, for example. The information processing apparatus 20 may be a personal computer (PC), or a computer included in a server storing therein and managing information. The information processing apparatus 20 is a specialized or general-purpose computer, for example. The information processing apparatus 20 may be a personal computer (PC), or a computer included in a server storing therein and managing information.

The information processing apparatus 20 includes a processing circuit 32, a memory circuit 34, and a communicating unit 36. The processing circuit 32, the memory circuit 34, and the communicating unit 36 are connected to one another through a bus. The information processing apparatus 20 is connected to the image capture device 12, the input device 22, and the display device 24 through a bus, for example.

The processing circuit 32 is a processor that implements a function corresponding to a computer program by reading the computer program from the memory circuit 34 and executing the computer program. The processing circuit 32 having read a computer program includes the units illustrated in the processing circuit 32 in FIG. 1. In other words, the processing circuit 32 functions as an acquirer 42, a detector 44, an estimator 46 (determiner), a converter 48, and an output unit 50 by executing the computer program. Each of these units will be explained later in detail.

The processing circuit 32 may be implemented as one processor, or a plurality of independent processors. Furthermore, the processing circuit 32 may also implement a specific function by causing a dedicated independent computer program execution circuit to execute a computer program.

The term “processor” means a circuit such as a central processing unit (CPU), a graphical processing unit (GPU), an application specific integrated circuit (ASIC), and a programmable logic device (such as a simple programmable logic device (SPLD), a complex programmable logic device (CPLD), and a field programmable gate array (FPGA)). The processor implements a function by reading and executing a computer program stored in the memory circuit 34. Instead of storing the computer program in the memory circuit 34, the computer program may be embedded directly in the processor circuit. In such a configuration, the processor implements the function by reading and executing the computer program embedded in the circuit.

Stored in the memory circuit 34 is a computer program for causing the processing circuit 32 to function as the acquirer 42, the detector 44, the estimator 46, the converter 48, and the output unit 50. The memory circuit 34 stores therein data and the like related to the processing functions executed by the processing circuit 32.

The memory circuit 34 also stores therein a mapping relation used in object position calculations. The memory circuit 34 also stores therein captured images captured by the image capture device 12. The memory circuit 34 also stores therein various setting values used in the object position calculations and user interface images.

Examples of the memory circuit 34 includes a random-access memory (RAM), a semiconductor memory device such as a flash memory, a hard disk, and an optical disk. The process performed by the memory circuit 34 may alternatively be performed by a storage device external to the information processing apparatus 20. The memory circuit 34 may also be a storage medium storing therein or temporarily storing therein a computer program having been communicated and downloaded over a local area network (LAN) or the Internet. The number of the storage medium is not limited to one, and configurations using a plurality of mediums to execute a process according to the embodiment still fall within the scope of the storage medium according to the embodiment, and the medium may be configured in either way.

The communicating unit 36 is an interface for inputting and outputting information from and to an external device connected over the wire or wirelessly. The communicating unit 36 may perform communications by connecting to a network.

The input device 22 receives various types of instructions and information inputs from a user. The input device 22 is an input device examples of which include a pointing device such as a mouse and a track ball, and a keyboard.

The display device 24 displays various types of information, such as image data. An example of the display device 24 includes a liquid crystal display.

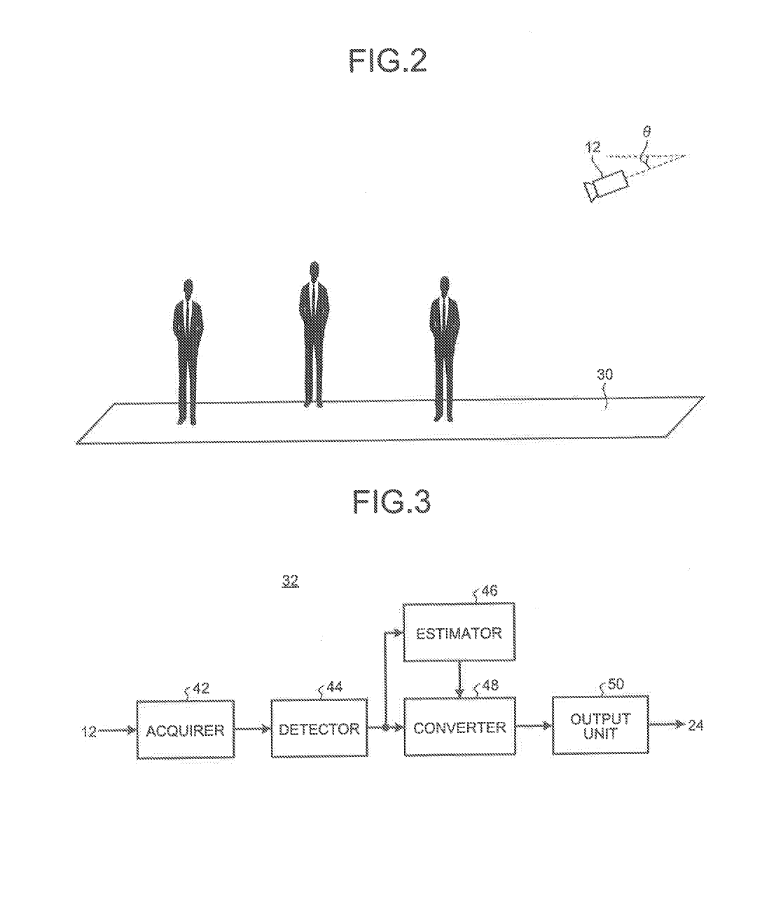

FIG. 2 is a schematic illustrating a positional relation between a plane of movement 30 on which objects move, and the image capture device 12. The objects move on the plane of movement 30. Objects may temporarily remain at the same position on the plane of movement 30. When the object is a person, for example, the plane of movement 30 is a road or a floor of a building.

The plane of movement 30 is a flat surface, for example. The plane of movement 30 may partially include a slope or stairs, for example. The entire plane of movement 30 may be tilted diagonally.

The image capture device 12 captures an image of the objects moving on the plane of movement 30 from above at a predetermined angle (angle of depression θ). For example, when the object is a person, the image capture device 12 captures an image of the plane of movement 30, such as a floor of a station or a building, at a predetermined angle of depression. The image capture device 12 is fixed.

Individual differences between the objects in size are relatively small, with respect to the range captured by the image capture device 12 (angular field). For example, when the object is a person, the objects have a size ranging from one meter to two meters or so.

FIG. 3 is a schematic illustrating a functional configuration of the processing circuit 32 according to the first embodiment. The processing circuit 32 includes the acquirer 42, the detector 44, the estimator 46, the converter 48, and the output unit 50.

The acquirer 42 acquires a captured image capturing the image of objects moving on the plane of movement 30 that is captured by the image capture device 12 from a fixed viewpoint. The acquirer 42 acquires a captured image from the image capture device 12, for example. In a configuration in which the captured image captured by the image capture device 12 is stored in the memory circuit 34, the acquirer 42 may acquire the captured image from the memory circuit 34.

The detector 44 detects the objects included in each of the captured images acquired by the acquirer 42. The detector 44 then detects the coordinates (the position of the object in the captured image) and the size of each of the objects in the captured image. The object detection process performed by the detector 44 will be described later in further detail, with reference to FIG. 5, for example.

The estimator 46 determines a mapping relation based on the coordinates and the size of the object detected by the detector 44 in the captured image. A mapping relation is information indicating a relation between the coordinates of the object in the captured image and the position of the object in a virtual plane of movement that is a representation of the plane of movement 30 viewed from a predetermined direction.

The virtual plane of movement may be map information (map information in a top view) in which the plane of movement 30 viewed from the vertical direction is represented two dimensionally, as an example. The virtual plane of movement may be map information (map information in a quarter view) in which the plane of movement 30 viewed from a predetermined direction other than the vertical direction is represented three dimensionally, as another example.

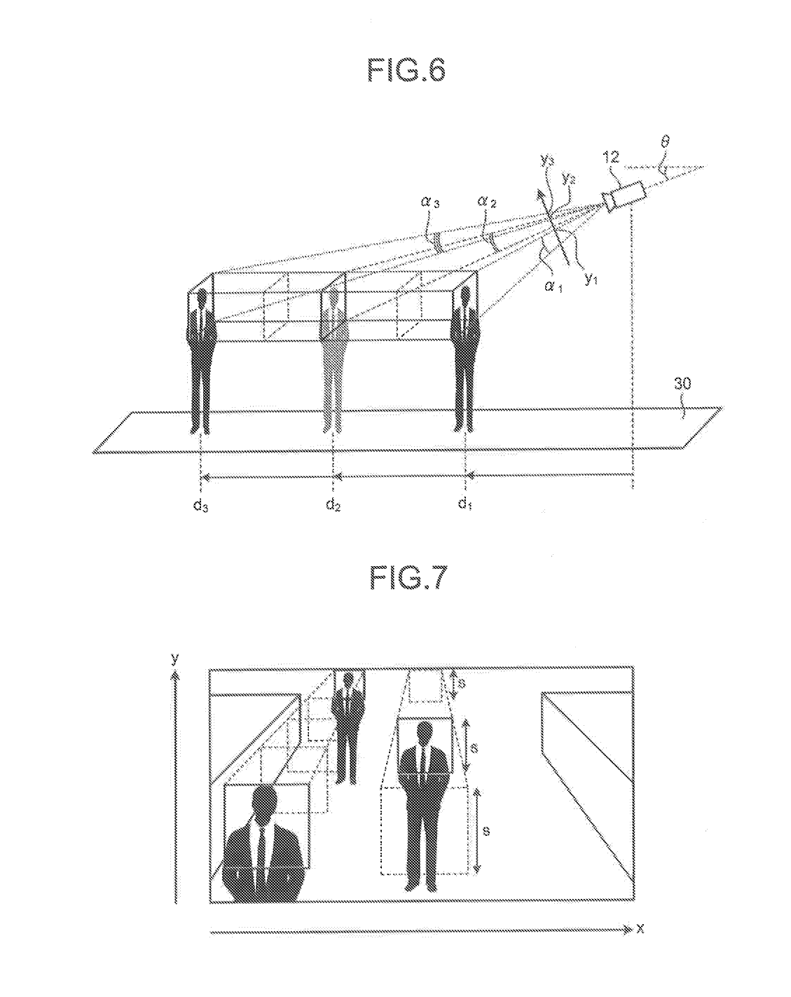

The mapping relation may be represented as a mathematical formula or a table, for example. An estimation process performed by the estimator 46 will be described later in detail with reference to FIGS. 6 and 7, for example.

The converter 48 acquires the mapping relation estimated by the estimator 46. The converter 48 then converts the coordinates of the object in the captured image detected by the detector 44 into the position of the object on the virtual plane of movement, based on the acquired mapping relation.

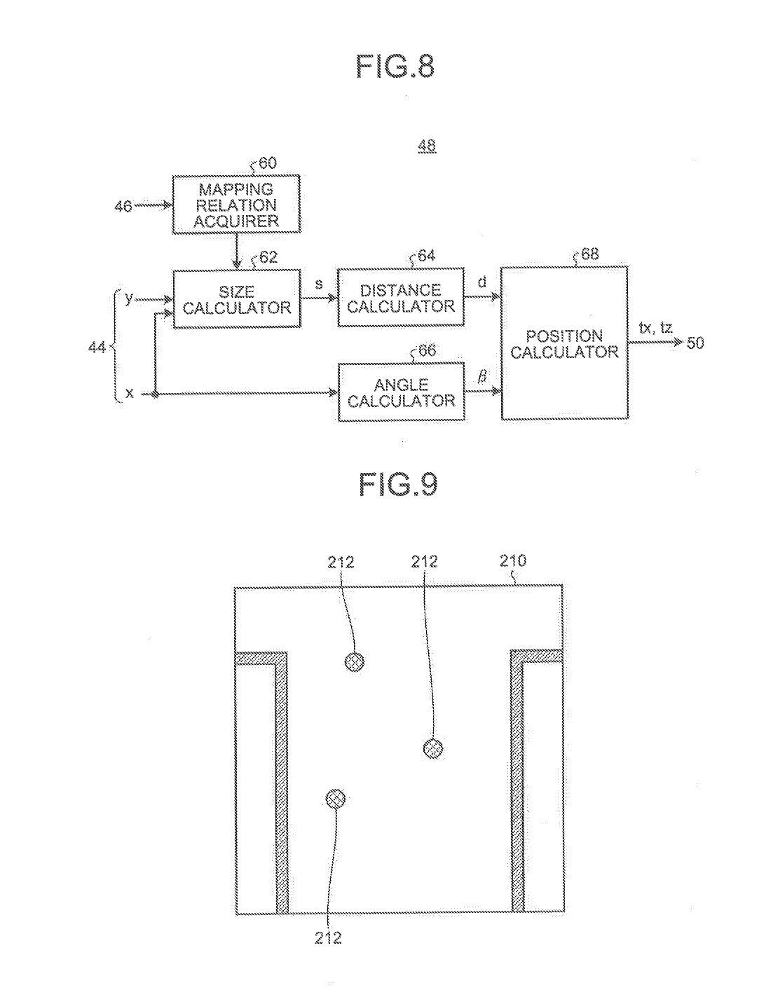

For example, when the virtual plane of movement is a top view of the plane of movement 30, the converter 48 converts the coordinates of the object, in the captured image into the position in the top view of the plane of movement 30. Ac this time, if the mapping relation is represented as a conversion formula, the converter 48 converts the coordinates in the captured image into the position in the top view by performing an operation using the conversion formula. If the mapping relation is represented as a table, the converter 48 converts the coordinates in the captured image into the position in the top view by making a reference to the table. An exemplary configuration of the converter 48 will be described later with reference to FIG. 8, for example.

The output unit 50 outputs an output image representing the virtual plane of movement and appended with object information indicating the presence of the object. The output unit 50 appends the object information to the coordinates corresponding to the position of the object in the output image. The output unit 50 then supplies the output image to the display device 24, and causes the display device 24 to display the output image.

The output image may be, for example, an image of the map information of the top view of the plane of movement 30 represented two dimensionally. In this case, the output unit 50 appends the object information to the coordinates corresponding to the position of the object in the output image.

The object information may be an icon representing an object. For example, when the object is a person, the output unit 50 may append an icon representing a person to the coordinates corresponding to the position, of a person in the output image. In this manner, the output unit 50 enables users to recognize where the object is present in the map intuitively.

The estimator 46 may estimate the mapping relation every time the detector 44 detects the position and the coordinates of an object in one captured image. In this case, the estimator 46 may estimate the mapping relation using the position and the coordinates of the objects having been detected in the past. When the accuracy of the mapping relation reaches a level equal to or higher than a predetermined level, as a result of estimating the mapping relation using the positions and the coordinates of the objects in a number equal to or greater than a certain number, the estimator 46 may end the process of estimating the mapping relation. In this manner, the processing circuit 32 can reduce the subsequent computational cost.

When the converter 48 has ended the mapping relation estimation process, the converter 48 may executes the subsequent process using the last mapping relation calculated. When the converter 48 has ended the mapping relation estimation process, the detector 44 may omit outputting of the object size. Furthermore, the processing circuit 32 may cause the estimator 46 to operate and to execute the mapping relation estimation process during the calibration, and may not cause the estimator 46 to operate during the actual operations.

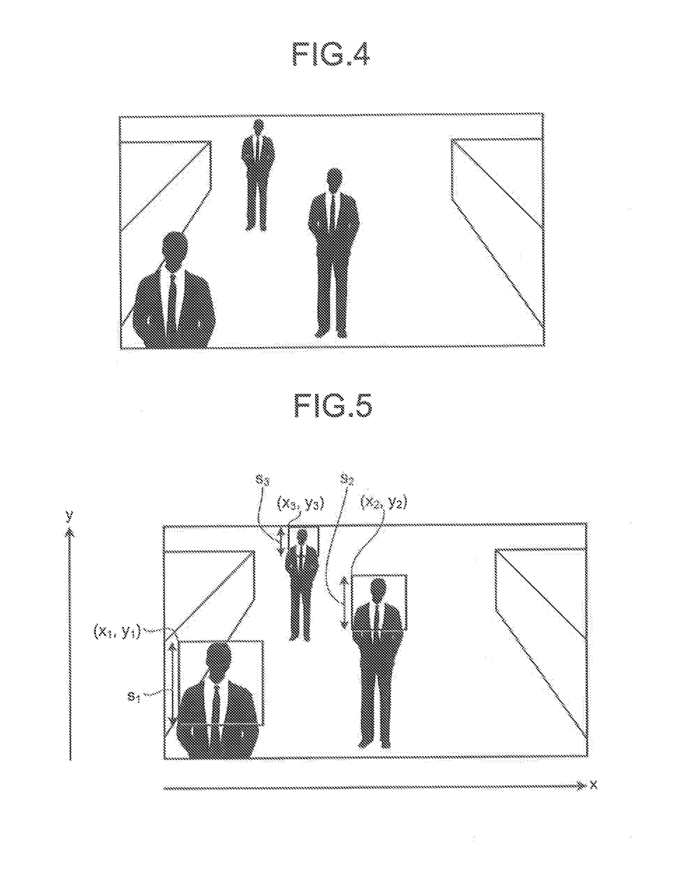

FIG. 4 is a schematic illustrating an example of a captured image including objects. The acquirer 42 acquires the captured image including persons as objects, for example, as illustrated in FIG. 4.

FIG. 5 is a schematic illustrating an example of the positions and the sizes of objects in a captured image. The detector 44 analyzes each of the captured images acquired by the acquirer 42, and detects the coordinates and the size of each of the objects included in the captured image.

When the object is a person, the detector 44 may detect the face, the head, the upper torso, the entire body, or a predetermined body part of a person, for example. In the example illustrated in FIG. 5, the detector 44 detects a portion including a head and the upper part of an upper torso, using a rectangular detection window.

The detector 44 then detects the coordinates of the detected object in the captured image. For example, the detector 44 may detect the coordinates of the center or a predetermined corner of the rectangular detection window in the captured image.

In the example illustrated in FIG. 5, x denotes a coordinate in the horizontal direction, and y denotes a coordinate in the height direction of the captured image. The same applies in the captured images illustrated in the subsequent drawings. In the example illustrated in FIG. 5, the detector 44 detects (x₁, y₁) as the coordinates of a first object, detects (x₂, y₂) as the coordinates of a second object, and detects (x₃, y₃) as the coordinates of a third object.

The detector 44 also detects the size of the detected object in the captured image. The size is a distance between two points in a predetermined portion of the object included in the captured image. For example, when the object is a person, the size may be the vertical length or the horizontal width of the head, of the upper torso, or of the entire body. The size may be the length between two eyes. For example, in the example illustrated in FIG. 5, the detector 44 detects the height-direction length of the rectangular detection window for detecting the portion including the head and the upper part of the upper torso, as the size. In the example illustrated in FIG. 5, the detector 44 detects s₁ as the size of the first object, detects s₂ as the coordinates of the second object, and detects s₃ as the coordinates of the third object. When the detector 44 detects the objects using a rectangular detection window, the detector 44 may detect the horizontal width or the length of a diagonal of the detection window as the size.

The detector 44 may detect an object by removing overdetection. Over-detection is a process in which areas other than the objects are detected as the objects. The detector 44 may perform a process of controlling a detection likelihood threshold, or a process of detecting a difference with the background and detecting the objects by excluding unmoving parts, for example. The detector 44 may also perform a process of connecting objects positioned at proximity or the objects having a similar size within the image as one object, for example.

FIG. 6 is a schematic illustrating a relation between the angular field and the positions of the object in a space, and the positions of the object in the captured image. In the detection system 10, the image capture device 12 is disposed at a fixed position, and objects move on the fixed plane of movement 30. The objects have substantially the same size regardless of individual differences.

Denoting the distance from a projected position of the image capture device 12, projected onto the plane of movement 30, to the object as d, and denoting the angular field occupied by the object in the captured image as α, α decreases as d increases. In other words, when the object moves away from the image capture device 12, the size of the object occupying the captured image is decreased.

For example, assuming that the angular field of the object is α₁ at a distance of d₁, the angular field of the object is α₂ at a distance of d₂, and the angular field of the object is α₃ at a distance of d₃, as illustrated in FIG. 6, if d₁<d₂<d₃ is established, a relation α₁>α₂>α₃ is then established.

Denoting the coordinate of the object in the height direction in the captured, image as y, y increases as d increases. In other words, when the object moves away from the image capture device 12, the object comes to a higher position in the captured image.

For example, it is assumed that the y coordinate of the object in the captured image is y₁ at the distance of d₁, the y coordinate of the object in the captured image is y₂ at the distance of d₂, and the y coordinate of the object in the captured image is y₃ at the distance of d₃, as illustrated in FIG. 6. The y coordinate takes a smaller value at a lower position (further toward the plane of movement 30). In this case, if d₁<d₂<d₃ is established, a relation y₁<y₂<y₃ is then established.

As described above, in the detection system 10, there is a correlation between the distance d from the image capture device 12 to the object and the angular field by which the object occupies the captured image. In the detection system 10, there also is a correlation between the distance d from the image capture device 12 to the object, and the coordinates of the object in the captured image.

Furthermore, the angular field by which the object occupies the captured image represents the size of the captured image occupied by the object. Therefore, in the detection system 10, there is a correlation between the coordinates of the object and the size of the object in the captured image.

FIG. 7 is a schematic illustrating a relation between the coordinates and the size of the object in the captured image. The estimator 46 estimates a mapping relation between the size of the object and the coordinates of the object in the captured image based on the coordinates of the object included in the captured image, and the detection result of the size of the object.

For example, the estimator 46 estimates a regression equation representing the correlation between the size and the coordinates of the object in the captured image. More specifically, the estimator 46 estimates a regression equation expressed as Equation (1) below including the size of the object as an objective variable, and a coordinate of the object in the captured image as an explanatory variable.

s=(a×y)+b (1)

In Equation (1), s denotes the size of the object, y denotes the coordinate of the object in the vertical direction of the captured image, and a and b denote constants.

The estimator 46 estimates a and b, which are the constants in the regression equation based on the detection results of at least two or more objects whose sizes are different. For example, the estimator 46 estimates a and b using a method such as the least-squares method, the principal component analysis, or the random sample consensus (RANSAC).

The estimator 46 can estimate the mapping relation (such as a regression equation) if the estimator 46 can acquire the detection results of at least two objects art different coordinates. The estimator 46 may also estimate the mapping relation (such as a regression equation) based on the detection results of at least two objects included in two or more captured images captured at different time. The estimator 46 may also estimate the mapping relation (such as a regression equation) based on the detection results of at least two objects included in one captured image. The estimator 46 may also accumulate detection results of the past, and estimate the regression equation based on the accumulated detection results.

If acquired is a captured image not including any object, or if acquired is an object with the same coordinates and the same size as those of previously acquired objects, the estimator 46 may skip the process of estimating a regression equation.

The estimator 46 may also estimate a regression equation expressed as following Equation (2), for example.

s=(a×x)+(b×y)+c (2)

In Equation (2), x denotes the coordinate of the object in the horizontal direction of the captured image, and c denotes a constant.

In the manner described above, by estimating a regression equation including a coordinate in the horizontal direction, the estimator 46 can estimate a correlation between the size and the coordinate of the object in the captured image accurately even when the image capture device 12 is tilted in the roll direction, for example.

The estimator 46 estimates a regression equation, such as those expressed as Equation (1) and Equation (2), as a mapping relation for converting the coordinate of an object in the captured image into the position of the object on the virtual plane of movement, which represents the plane of movement 30 viewed from a predetermined direction. The estimator 46 then feeds the regression equation, which is an estimation of the mapping relation, to the converter 48.

FIG. 8 is a schematic illustrating an exemplary functional configuration of the converter 43. When the estimator 46 estimates a regression equation including the size of the object as an objective variable, and the coordinate of the object in the captured image as an explanatory variable, the converter 48 may be configured as illustrated in FIG. 8. In other words, the converter 48 includes a mapping relation acquirer 60, a size calculator 62, a distance calculator 64, an angle calculator 66, and a position calculator 68.

The mapping relation acquirer 60 acquires the regression equation estimated by the estimator 46. For example, the mapping relation acquirer 60 acquires the regression equation expressed as Equation (1) or Equation (2).

The size calculator 62 then acquires the coordinates of the object included in the captured image. The size calculator 62 then calculates the size of the object from the coordinates of the object included in the captured image, using the estimated regression equation. If the regression equation is as expressed as Equation (1), the size calculator 62 calculates the size s of the object from the height-direction coordinate y of the object. If the regression equation is as expressed as Equation (2), the size calculator 62 calculates the size s of the object from, the horizontal-direction coordinate x and height-direction coordinate y of the object.

The distance calculator 64 calculates the distance from a first viewpoint (the position of the image capture device 12) to the object, based on the object size calculated by the size calculator 62. For example, the distance calculator 64 calculates the distance from the first viewpoint to the object using Equation (3).

d=(h×f)/s (3)

d denotes the distance from the first viewpoint (the position of the image capture device 12) to the object, and h denotes the size of the object in the real world. f denotes the focal distance of the image capture device 12.

h and f are set in the distance calculator 64 by the user or the like in advance. h and f do not necessarily need to be accurate values as long as a relative positional relation of the object in the output image can be specified. For example, when detected is an upper torso, 0.5 meters may be set as h in the distance calculator 64. As another example, when detected is a face, 0.15 meters may be set as h in the distance calculator 64. The distance calculator 64 feeds the calculated distance to the position calculator 68.

The angle calculator 66 acquires the horizontal-direction coordinate of the object included in the captured image. The angle calculator 66 calculates an angle of the object in the horizontal direction with respect to the optical axis of the image capture device 12 having captured the captured image, based on the horizontal-direction coordinate of the object included in the captured image.

For example, the angle calculator 66 calculates an angle of the object in the horizontal direction with respect to the optical axis of the image capture device 12 using Equation (4).

β={(x−(w/2))/(w/2)}×(γ/2) (4)

β denotes the angle of the object in the horizontal direction with respect to the optical axis of the image capture device 12. w denotes the size of the captured image in the horizontal direction. γ denotes the angular field of the captured image.

w and γ are set in the angle calculator 66 by the user or the like in advance. w and γ do not necessarily need to be accurate values as long as a relative positional relation of the object in the output image can be specified. For example, 45 degrees, which is an angular field of a general camera, may be set as γ in the angle calculator 66. A user may be permitted to select from a plurality of angular fields such as “normal”, “narrow”, and “wide”. For example, when the “normal” is selected, 45 degrees may be set as γ in the angle calculator 66. When the “narrow” is selected, 30 degrees may be set as γ in the angle calculator 66, and when the “wide” is selected, 90 degrees may be set as γ in the angle calculator 66. The angle calculator 66 feeds the calculated angle to the position calculator 68.

The position calculator 68 calculates the position of the object on the virtual plane of movement based on the distance from the first viewpoint (the position of the image capture device 12) to the object, and on the angle of the object in the horizontal direction with respect to the optical axis of the image capture device 12. For example, when the virtual plane of movement is top view information representing the plane of movement 30 viewed from the vertical direction, the position calculator 68 calculates the position of the object on the virtual plane of movement based on Equation (5) and Equation (6).

tx=d×cos(β) (5)

ty=d×sin(β) (6)

In Equation (6), ty denotes the position in the direction in which the optical axis of the image capture device 12 is projected (y direction) onto the virtual plane of movement. In Equation (5), tx denotes the position in the direction perpendicular to the direction in which the optical axis of the image capture device 12 is projected (x direction) onto the virtual plane of movement.

In Equation (5) and Equation (6), the position at which the first viewpoint (the image capture device 12) is projected onto the virtual plane of movement is used as the reference position ((tx, ty)=0). To use a point other than the first viewpoint as the reference position, the position calculator 68 can move the coordinates calculated by Equation (5) and Equation (6) in parallel.

FIG. 9 is a schematic illustrating an example of an output image output from the detection system 10 according to the first embodiment. The output unit 50 outputs an output image representing the virtual plane of movement. The output unit 50 causes the display device 24 to display the output image, for example.

The virtual plane of movement is information representing the plane of movement 30 viewed from a predetermined direction. In the embodiment, the virtual plane of movement is map information that is a two-dimensional representation of the top view of the plane of movement 30 viewed from the vertical direction.

Appended by the output unit 50 to the output image representing such a virtual plane of movement (such as map information) are pieces of object information indicating the presence of objects. Specifically, the output unit 50 appends the object information to the coordinates corresponding to the position of the object in the output image.

For example, the output unit 50 appends an icon to the output image as the object information. For example, as illustrated in FIG. 9, the output unit 50 appends a circular object icon 212 indicating the presence of each person to the first output image 210. In this case, the output unit 50 appends the object icon 212 to the coordinates corresponding to the position of the object output from the converter 48, in the first output image 210.

The output unit 50 may append any information other than the icon to the output image, as the object information indicating the presence of an object. For example, the output unit 50 may append a symbol, a character, or a number, for example, as the object information. The output unit 50 may also append information such as a luminance, a color, or a transparency that is different from that of the surroundings, as the object information.

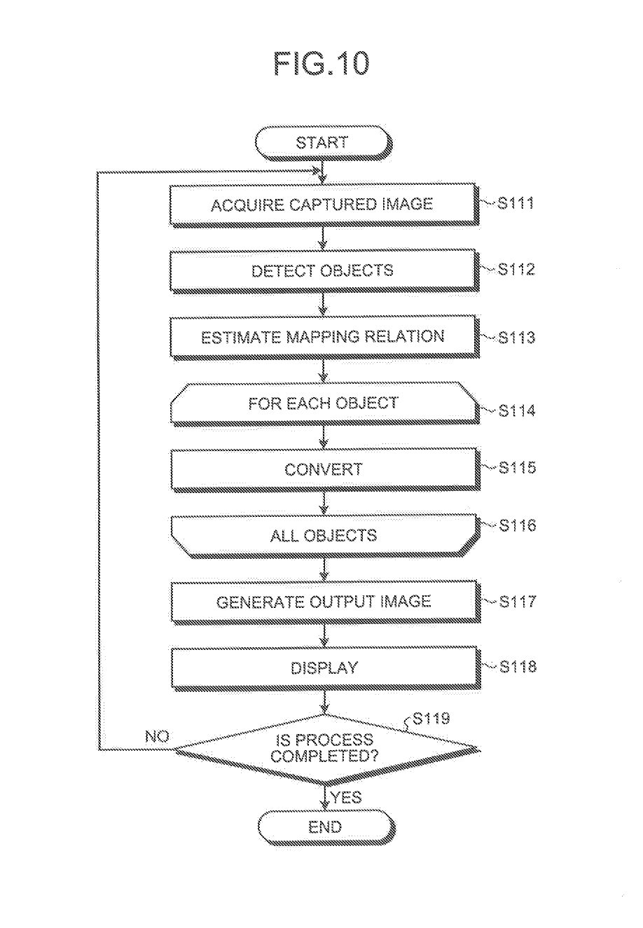

FIG. 10 is a flowchart illustrating the sequence of a process performed in the detection system 10. The detection system 10 performs the process following the sequence of the flowchart illustrated in FIG. 10.

To begin with, the detection system 10 acquires a captured image capturing the objects that are moving on the plane of movement 30 from a fixed viewpoint (S111). The detection system 10 then detects the objects included in the acquired captured image (S112). The detection system 10 then detects the coordinates and the size of each of the detected objects in the captured image. If no object is detected in the captured image at S112, the detection system 10 returns the process back to S111, and the process proceeds to the next captured image.

The detection system 10 then estimates a mapping relation based on the detected coordinates and the size of each of the objects in the captured image (S113). The mapping relation is a relation for converting the coordinates of the object in the captured image into the position of the object on the virtual plane of movement. The detection system 10 may also estimate the mapping relation by using the coordinates and the size of the objects having been detected in the past.

The detection system 10 then performs the conversion process to each, of the objects included in the captured image (S114, S115, S116). Specifically, the detection system 10 converts the coordinates of the object in the detected captured image into the position of the object on the virtual plane of movement based on the estimated mapping relation.

The detection system 10 then generates an output image appended, with the object, information indicating the presence of the objects (S117). Specifically, the output unit 50 appends the object information such as icons to the coordinates corresponding to the positions of the respective objects in the output image representing the virtual plane of movement (such as map information).

The detection system 10 then displays the generated output image (S118). The detection system 10 then determines whether the process is completed (S119). If the process is not completed (No at S119), the detection system 10 returns the process back to S111, and the process proceeds to the next captured image. If the process is completed (yes at S119), the detection system 10 ends the process.

As described above, based on a captured image of the objects moving on the plane of movement 30 captured from a fixed viewpoint, the detection system 10 according to the embodiment can accurately calculate the position of the objects on the virtual plane of movement which is a representation of the plane of movement 30 viewed from a predetermined direction. Furthermore, the detection system 10 according to the embodiment can append information indicating the presence of each object to the position of the corresponding object in the output image representing the virtual plane of movement. Therefore, with the detection system 10 according to the embodiment, the users can easily recognize the positions of the objects.

### Second Embodiment

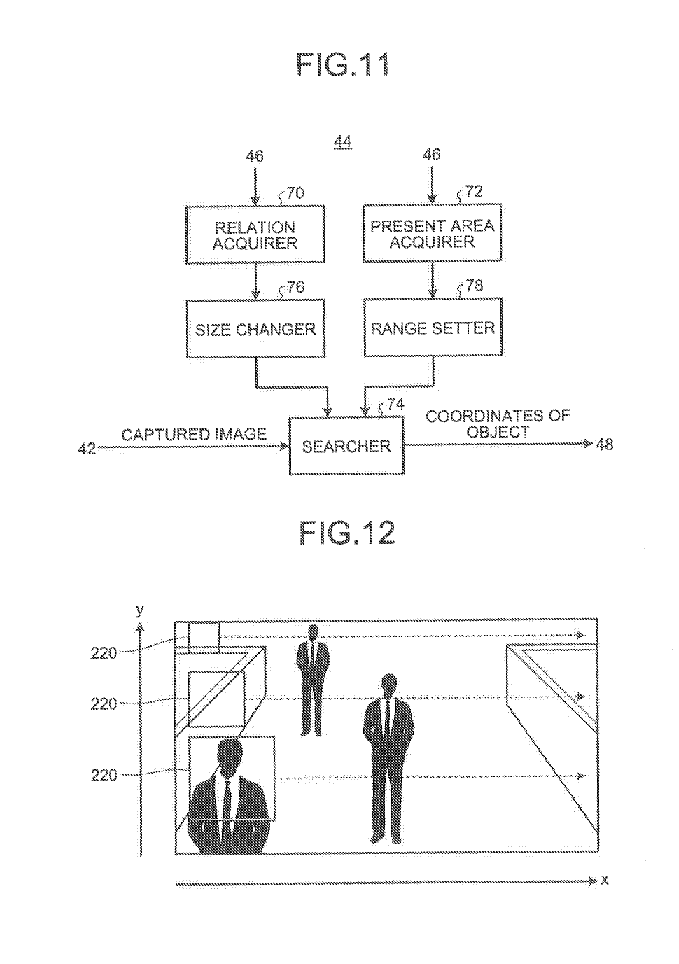

FIG. 11 is a schematic illustrating a functional configuration of the detector 44 according to a second embodiment.

The estimator 46 according to the embodiment estimates a regression equation representing a relation between the size of the object and the coordinates of the object in the captured image. In addition, the estimator 46 estimates a present area that can have some objects in the captured image, and an absent area that does not have any object in the captured image, based on the detection results of a plurality of objects. For example, the estimator 46 maps the position at which the objects are detected to the same coordinate space as the captured image, analyzes the mapping result, and estimates the present area having some object, and the absent area having no object.

The detector 44 according to the embodiment includes a relation acquirer 70, a present area acquirer 72, a searcher 74, a size changer 76, and a range setter 78.

The relation acquirer 70 acquires a mapping relation representing mapping between the size and the coordinates of the object in the captured image from the estimator 46 in advance. For example, the relation acquirer 70 acquires the regression equation estimated by the estimator 46 in advance. The present area acquirer 72 acquires the present area estimated by the estimator 46 in advance.

The searcher 74 acquires the captured image from the acquirer 42. The searcher 74 detects whether an object is in each set of detection coordinates while moving the detection coordinates in the captured image. For example, the searcher 74 detects the object while performing raster-scanning of the captured image. When an object is detected, the searcher 74 feeds the coordinates of the detected object to the converter 48.

As the detection coordinates are scanned, the size changer 76 changes the size of the object to be detected by the searcher 74. The size changer 76 changes the size of the object to be detected by the searcher 74 to a size determined based on the detection coordinates and the mapping relation. For example, the size changer 76 calculates the size of the object corresponding to the detection coordinates based on the regression equation, and sets the calculated size in the searcher 74. The searcher 74 then detects the objects having the set size for each set of the detected coordinates.

The range setter 78 sets the present area in the searcher 74 as a range in which the detection process is to be executed. The searcher 74 then searches the set range so as to detect the objects.

FIG. 12 is a schematic illustrating a detection size of the object to be detected by the detector 44. For example, the searcher 74 detects the object by analyzing the image inside of a rectangular first detection window 220 for detecting the objects, while moving the coordinates of the first detection window 220. In this manner, the searcher 74 can detect the object with a size equivalent to the size of the first detection window 220.

The searcher 74 changes the size of the first detection window 220 under the control of the size changer 76. The size changer 76 calculates the size of the object by substituting the variables in the regression equation with the coordinates of the first detection window 220, and sets the size of the first detection window 220 to the calculated size of the object. In this manner, the searcher 74 does not need to detect the objects in every size in each set of coordinates, and therefore the objects can be detected with lower computational cost.

The searcher 74 may detect the object by changing the size of the first detection window 220 at a predetermined ratio (for example, ±20 percent or so) with respect to the set size, in each set of the detection coordinates. In this manner, the searcher 74 can detect an object even when the regression equation has some estimation error.

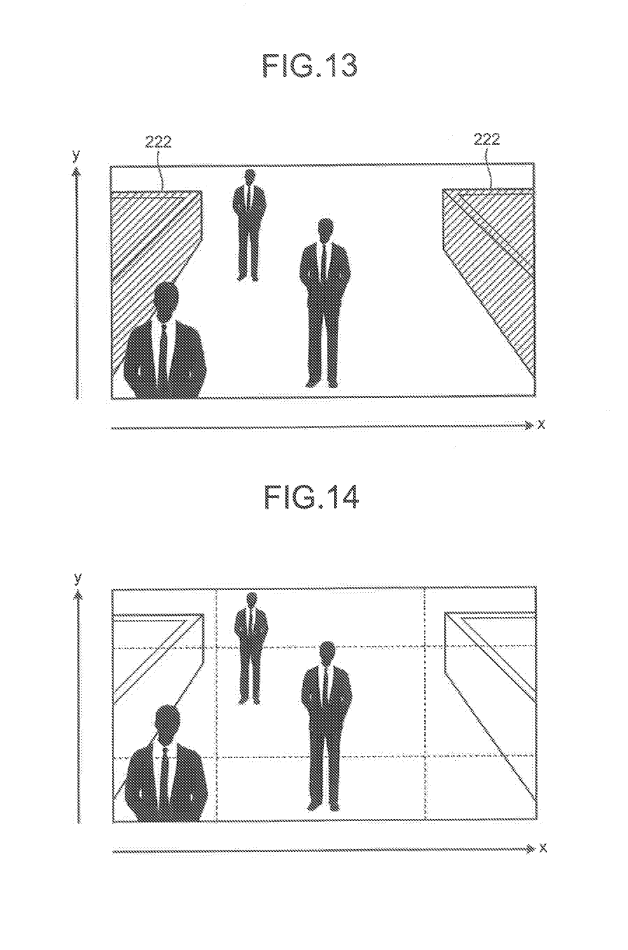

FIG. 13 is a schematic illustrating an example of a captured image indicating absent areas in which no object is presumed to be present. When detected as the objects are persons walking through a passageway, it is highly likely that there is no object in places other than the passageway. For example, in the captured image illustrated in FIG. 13, first absent areas 222 indicated as hatched are estimated not to include any persons, which are the objects.

The searcher 74 then detects objects by searching the area (present area) other than the absent areas in the captured image. In this manner, the searcher 74 does not need to search the entire area of the captured image, and therefore, the objects can be detected with lower computational cost. Furthermore, because the searcher 74 detects the objects by searching the areas other than the absent areas in the manner described above, overdetection in the absent areas can be avoided.

### Third Embodiment

FIG. 14 is a schematic illustrating divided areas that are a plurality of divisions of a captured image. In a third embodiment, the estimator 46 estimates a mapping relation for each of the divided areas of the captured image. For example, the estimator 46 estimates a regression equation representing a correlation between the size and the coordinates of the object in the captured image for each of the divided areas.

The divided areas are divisions of the captured image, divided into three vertically and three horizontally, for example, as illustrated in FIG. 14. The estimator 46 then feeds the mapping relation (such as the regression equation) estimated for each of the divided areas to the converter 48.

When the object is detected, the converter 48 identifies the divided areas including the detected object. The converter 48 then calculates the position of the object on the virtual plane of movement based on the estimated mapping relation (such as the regression equation) corresponding to the identified divided area. In this manner, with the detection system 10 according to the embodiment, even when the captured image is distorted by the lens or has some parts where the plane of movement 30 is inclined by different degrees, for example, the position of the object on the virtual plane of movement can be calculated accurately across the entire area of the captured image.

Some captured images may have divided areas that include objects and divided areas that include no object. For the divided areas not including any object, the estimator 46 skips the mapping relation estimation process. For the divided areas for which the mapping relation estimation process is skipped, the converter 48 does not perform the conversion process because the area does not include any object.

The estimator 46 may change the borders between the divided areas in such a manner that the estimation error is reduced. For example, the estimator 46 changes the borders between the divided areas, and compares the sum of estimation errors in the divided areas before the change, with the sum of the estimation errors in the divided areas after the change. If the sum of the estimation errors in the divided areas after the change is smaller, the estimator 46 then estimates a mapping relation for each of the divided areas with the borders after the change.

The estimator 46 may also change the number of divided areas in such a manner that the sum of the estimation errors is reduced. For example, the estimator 46 increases or decreases the number of divided areas, and compares the sum of the estimation errors in the divided areas before the change with the sum of the estimation errors in the divided areas after the change. If the sum of the estimation errors in the divided areas after the change is smaller, the estimator 46 then estimates a mapping relation for each of the divided areas with the borders after the change.

If the mapping relations in the adjacent two divided areas are similar, the estimator 46 may also synthesize adjacent two divided areas, which have similar mapping relations, into one divided area.

### Fourth Embodiment

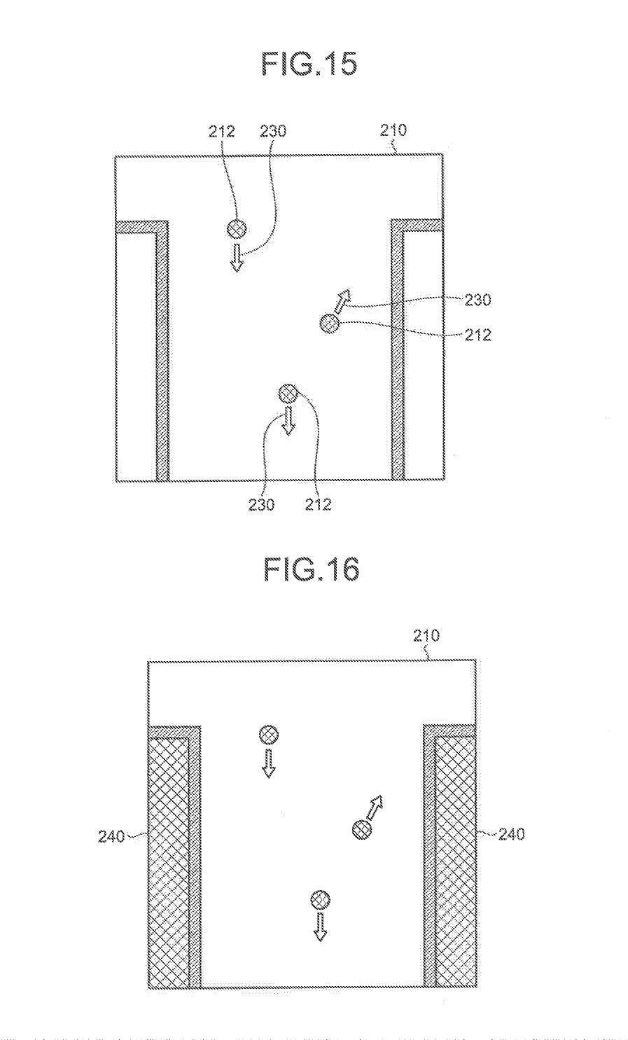

FIG. 15 is a schematic illustrating an example of an output image appended with moving directions of respective objects.

In this embodiment, the output unit 50 detects the moving directions of the respective objects based on the positions of the respective objects detected from image captures performed for a plurality of number of times that are temporarily continuous. The output unit 50 calculates the moving directions using a technology such as the optical flow, for example. The output unit 50 may then append icons including the moving directions of the respective objects to the output image, as the object information.

For example, the output unit 50 may append the object icons 212 indicating the presence of persons, and arrow icons 230 indicating the moving directions of the respective persons to the first output image 210, as illustrated in FIG. 15. Instead of using two icons, the output unit 50 may append one icon capable of identifying the moving direction. In this case, the output unit 50 changes the orientation of the icon in accordance with the moving direction of the corresponding object.

The detector 44 may also detect an attribute of the object. For example, when the object is a person, the detector 44 may detect attributes such as whether the person is a male or a female, and whether the person is an adult or a child.

The output unit 50 then appends an icon identifying the attribute of the corresponding object, as the object information, to the output image. For example, the output unit 50 may append an icon having a different shape or color depending on whether the person is a male or a female. The output unit 50 may also append an icon having a different shape or color depending on whether the person is an adult or a child. The output unit 50 may also append information representing the attribute using a symbol, a character, or a number, without limitation to an icon.

FIG. 16 is a schematic illustrating an example of an output image appended with non-existing areas in which no object is presumed to be present.

The output unit 50 detects a non-existing area estimated as not including any object on the virtual plane of movement based on the positions of a plurality of the respective objects on the virtual plane of movement. For example, the output unit 50 maps the positions at which the respective objects are detected onto the virtual plane of movement, and estimates the non-existing area having no object by analyzing the mapping results. When the estimator 46 has already estimated an absent area in the captured image, the output unit 50 may use a projection of the absent area estimated by the estimator 46 onto the virtual plane of movement as a non-existing area.

The output unit 50 then append a piece of information representing that there is no object to the area corresponding to the non-existing area in the output image. For example, the output unit 50 may append first non-existing areas 240 to the first output image 210, as illustrated in FIG. 16.

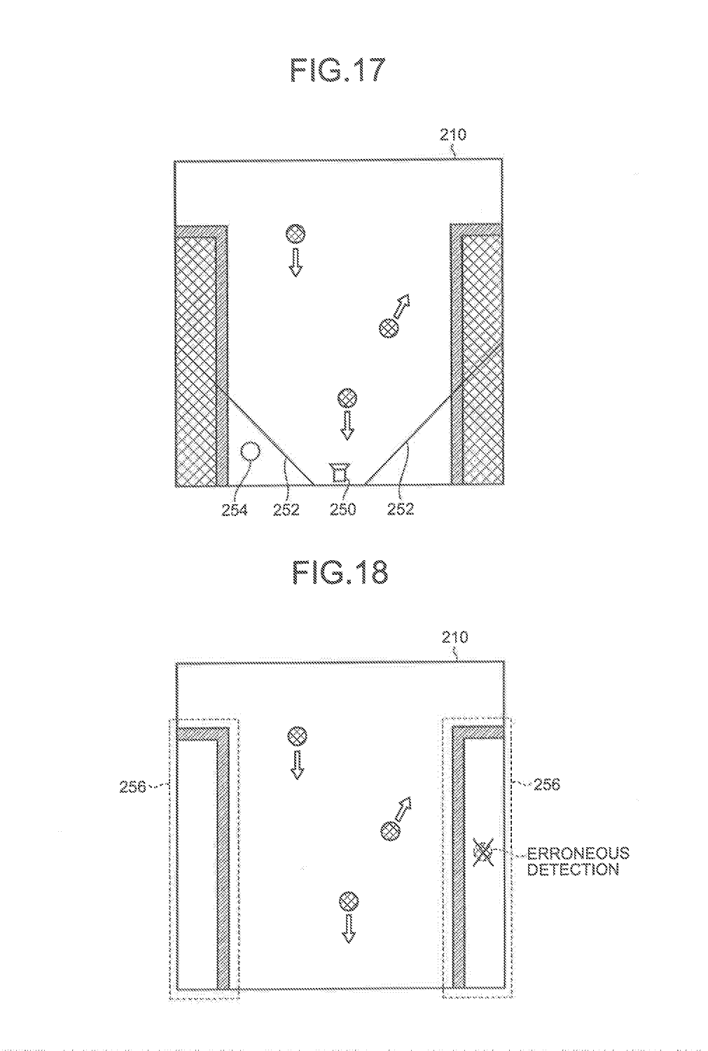

FIG. 17 is a schematic illustrating an example of an output image appended with information representing the positions of the objects that are present within and outside of the visual field of the captured image. The output unit 50 may also append information representing the visual field included in the captured image to the output image.

For example, the output unit 50 may append a camera icon 250 representing the position of the image capture device 12 projected onto the virtual plane of movement to the first output image 210. The output unit 50 may also append border lines 252 representing the visual field of the image capture device 12 to the first output image 210. In this manner, the detection system 10 enables users to recognize the visual field.

Furthermore, the output unit 50 may extrapolate the positions of the objects that are present in the area outside of the visual field, based on the positions and the movement information of the respective objects detected in the images captured in the past. For example, the output unit 50 extrapolates the positions of the respective objects that are present in the area outside of the visual field, using a technology such as the optical flow. The output unit 50 then appends the object information to the coordinates corresponding to the estimated positions in the output image.

For example, as illustrated in FIG. 17, the output unit 50 appends an extrapolation icon 254 representing an extrapolation of the object to the position outside of the visual field in the first output image 210. In this manner, the detection system 10 according to the embodiment enables users to recognize the objects present outside of the visual field on the virtual plane of movement. The output unit 50 may use a different icon to indicate the extrapolated position of the object from those used for the positions of the objects having been actually measured.

FIG. 18 is a schematic illustrating an example of an output image appended with non-existable areas. The output unit 50 may acquire the area in which no object can be present on the virtual plane of movement in advance. For example, when detected as the objects are persons who are walking on a passageway, the output unit 50 may acquire the area where no one can enter on the virtual plane of movement in advance.

The output unit 50 appends information representing the area in which no object can be present on the virtual plane of movement to the output image. For example, the output unit 50 appends first non-existable areas 256 representing the areas in which no object can be present to the first output image 210, as illustrated in FIG. 18. In this manner, the detection system 10 according to the embodiment enables users to recognize the area in which no object can be present.

The output unit 50 may also determine whether the positions of the objects output from the converter 48 are within the area specified as an area no object can be present. If the positions of the objects output from the converter 48 are within the area specified as the area no object can be present, the output unit 50 determines that the position of the object has been erroneously detected. For the object determined to have been erroneously detected, the output unit 50 does not append the corresponding object information to the output image. For example, if the position of the object is detected in the first non-existable area 256, as illustrated in FIG. 18, the output unit 50 determines the position to be erroneously detected, and appends no object information. In this manner, the detection system 10 according to the embodiment can append the object information to the output image accurately.

### Fifth Embodiment

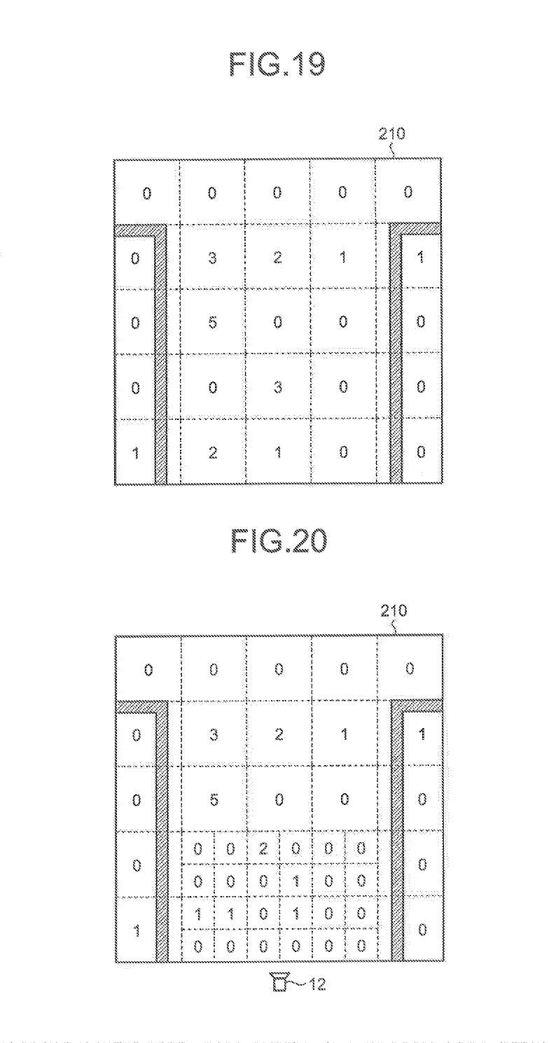

FIG. 19 is a schematic Illustrating an example of an output image appended with information representing the number of objects counted for each of a plurality of detection areas. The output unit 50 according to a fifth embodiment counts the number of objects that are present in each of a plurality of detection areas, which are the areas that are divisions of the virtual plane of movement. The output unit 50 then appends information representing the number of the objects included in each of the detection areas to the coordinates corresponding to the detection area in the output image, as the object information.

For example, the output unit 50 appends dotted lines partitioning the detection areas to the first output image 210, as illustrated in FIG. 19. The output unit 50 then appends a number representing the number of the objects to each of the detection areas partitioned by the dotted lines.

The detection area has a size in which a predetermined number of objects can be present. For example, the detection area may have a size in which one or more objects can be present. When the object is a person, the detection area may be an area corresponding to a size of two meters by two meters to 10 meters by 10 meters or so, for example.

When the object is detected at a border between two or more detection areas, the output unit 50 votes a value indicating one object (for example, one) to the tally of the detection area that covers the object at a higher ratio. Alternatively, the output unit 50 may vote a value indicating one object (for example, one) to the tally of each of the detection areas that include the object. The output unit 50 may also divide the value indicating one object (for example, one) in accordance with the ratios of the object in each of the detection areas, and vote the quotients to the respective tallies.

The output unit 50 may calculate, for each of a plurality of detection areas, the sum of the numbers of the objects acquired from a plurality of respective captured images that are temporarily different, and take an average. When some objects outside of the visual field have been estimated, the output unit 50 may also calculate the sum including the estimated objects.

FIG. 20 is a schematic illustrating detection areas divided in such a manner that the sizes of the detection areas become smaller toward the image capture device 12. The output unit 50 may use a smaller size for the detection areas corresponding to the positions nearer to the image capture device 12 than those of the detection areas corresponding to the positions further away from the image capture device 12. Parts of the captured image corresponding to the positions nearer to the image capture device 12 have more information than the parts corresponding to the positions further away from the image capture device 12. The output unit 50 can therefore count the number of the objects accurately, even when the detection areas are small.

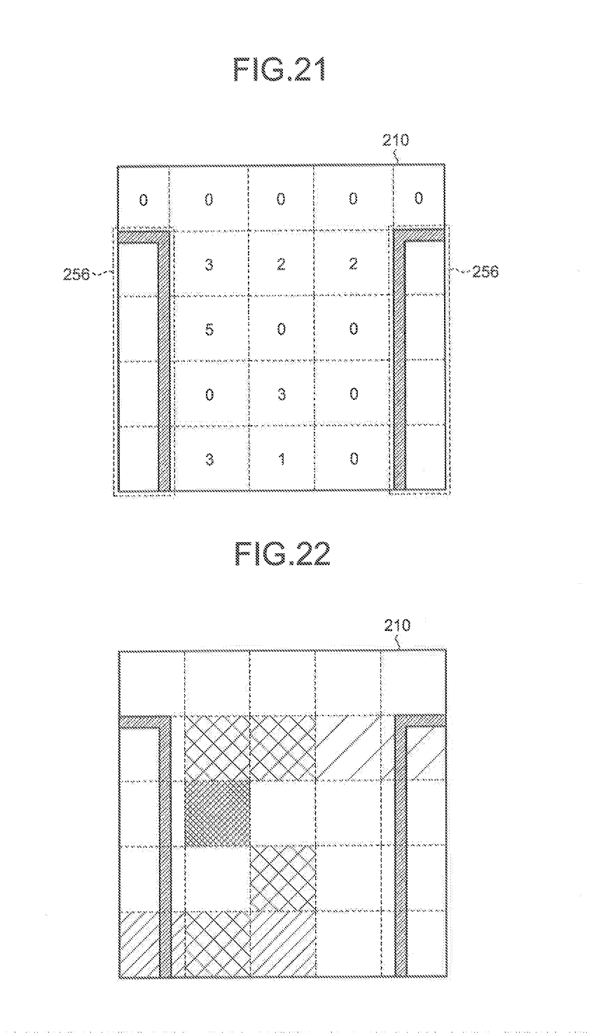

FIG. 21 is a schematic illustrating detection areas having their borders matched with the borders between a non-existable area where no object can be present and an existable area where objects can be present.

The output unit 50 acquires the area where no object can be present in advance, for example. When detected as the objects are persons who are walking on a passageway, for example, the output unit 50 may acquire the area where no one can enter on the virtual plane of movement in advance, as the area in which no object can be present. When the estimator 46 has already estimated the absent area in the captured image, the output unit 50 may use the projection of the absent area estimated by the estimator 46 onto the virtual plane of movement as the area in which no object can be present.

The output unit 50 may then match the border between the areas where the object can be present and where no object can be present with at least some of the borders between the detection areas. For example, the output unit 50 may match the borders of the first non-existable areas 256 representing the areas in which no object can be present with the borders of the detection areas, as illustrated in FIG. 21.

FIG. 22 is a schematic illustrating an example of an output image in which the number of the objects is indicated as a luminance. The output unit 50 may append a luminance, a color, an icon, a transparency, a character, or a symbol to the coordinates corresponding to each of the detection areas in the output image, as the information representing the number of the objects.

For example, the output unit 50 may change the luminance of the image in each of the detection areas in accordance with the number of the objects included the detection area, as illustrated in FIG. 22. For example, the output unit 50 may use a darker luminance for the detection areas with a larger number of objects, and use a lighter luminance for detection areas with a smaller number of objects. In this manner, the output unit 50 allows users to visually recognize the number of objects in each of the detection areas.

### Sixth Embodiment

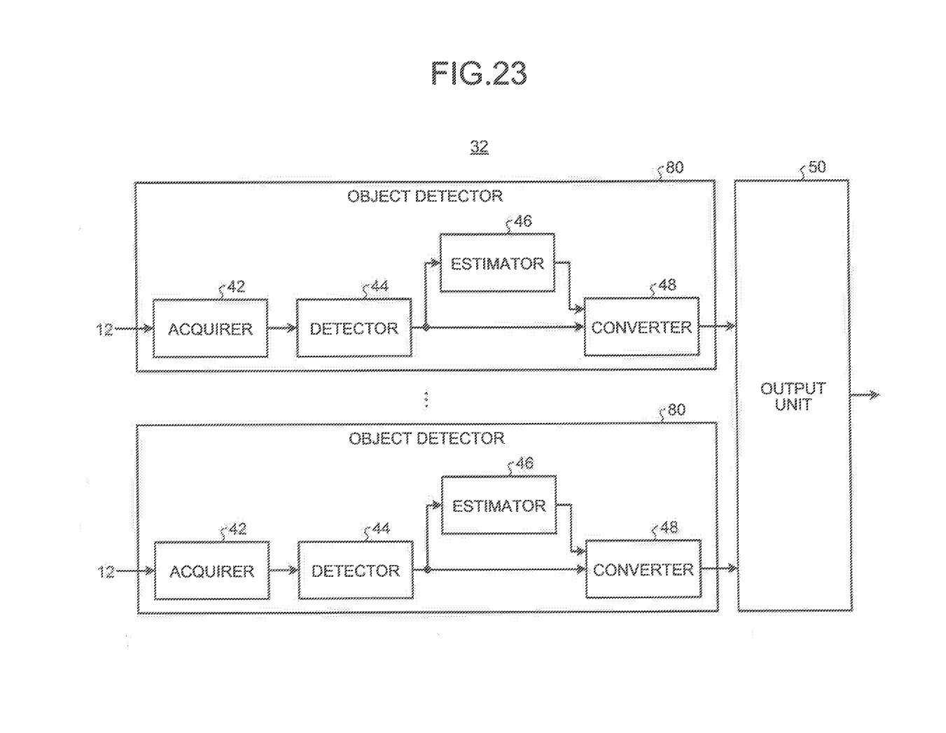

FIG. 23 is a schematic illustrating a functional configuration of a processing circuit 32 according to a sixth embodiment. The detection system 10 according to the sixth embodiment includes a plurality of image capture devices 12. The image capture devices 12 capture images of objects moving on the common plane of movement 30 from the respective different viewpoints. Each of the image capture devices 12 captures images of a road, a floor of a building, and the like from the different viewpoints.

The visual fields of the images captured by the image capture devices 12 may partially overlap one another. Furthermore, the image capture devices 12 may capture the object at the same angle of depression or at different angles of depression.

The processing circuit 32 according to the embodiment includes a plurality of object detectors 80, and the output unit 50. Each of the object detectors 80 has a one-to-one corresponding relation with the image capture devices 12. Each of the object detectors 80 includes the acquirer 42, the detector 44, the estimator 46, and the converter 48.

Each of the object detectors 80 acquires a captured image captured by the corresponding image capture device 12, and performs the process to the acquired captured image. In other words, each of the object detectors 80 acquires the captured image captured from a different viewpoint, and performs the process to the acquired captured image. Each of the object detectors 80 then outputs the positions of the object on the common virtual plane of movement. For example, each of the object detectors 80 outputs a position in the common coordinates.

The output unit 50 acquires the position of the object detected in the captured images acquired at the same time by the respective object detectors 80. The output unit 50 then appends the object information to the coordinates corresponding to the positions of the objects output from each of the object detectors 80 in the output image.

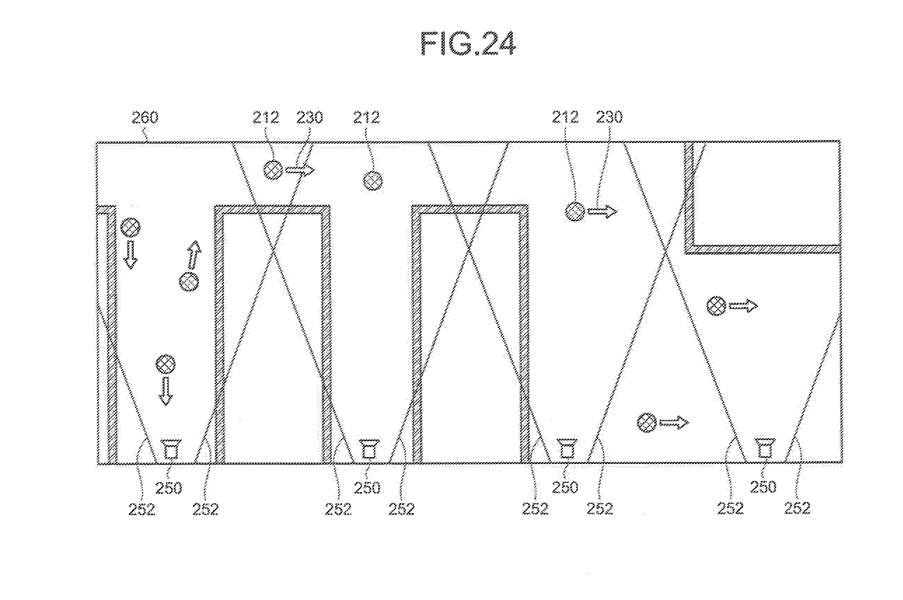

FIG. 24 is a schematic illustrating an example of an output image output from the detection system 10 according to the sixth embodiment. In the embodiment, the output unit 50 generates an output image including the visual fields of the respective image capture devices 12. For example, a second output image 260 illustrated in FIG. 24 includes the visual fields of four respective image capture devices 12. The output unit 50 may append the camera icons 250 representing the positions of the respective image capture devices 12 on the virtual plane of movement, and border lines 252 representing the visual fields of the image capture devices 12 that are represented as the camera icons 250 to the second output image 260, for example.

The output unit 50 then appends icons indicating the presence of the objects at the coordinates corresponding to the positions of the objects output from each of the object detectors 80 to the output image. For example, the output unit 50 appends the object icons 212 and the arrow icons 230 indicating the moving directions of the respective objects to the coordinates corresponding to the positions of the objects in the second output image 260, as illustrated in FIG. 24.

In the manner described above, the detection system 10 according to the embodiment can accurately calculate the positions of the objects on the virtual plane of movement representing the plane of movement 30 covering a wide area.

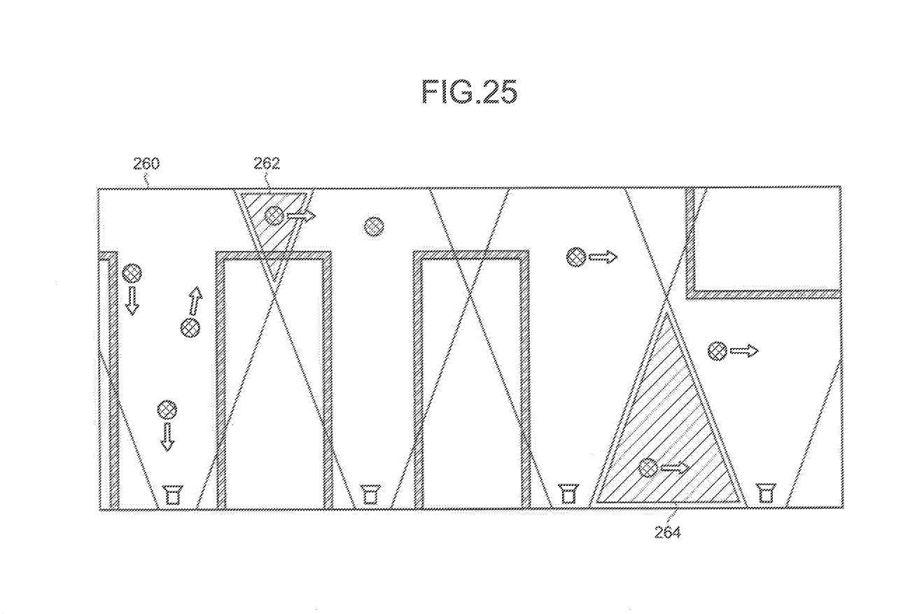

FIG. 25 is a schematic illustrating an area with overlapping visual fields, and areas not covered by any of the visual fields in the output image. When the output image including a plurality of image capture devices 12 is generated, the output image may include some areas in which a plurality of visual fields overlap one another. For example, a second output image 260 illustrated in FIG. 25 includes a first overlapping area 262 in which two visual fields overlap.

When a plurality of object detectors 80 detect an object in the overlapping area, output unit 50 may append the object information to the output image based on the position of the object output from one of the object detectors 80. In other words, when two or more object detectors 80 output positions for one object, the output unit 50 may append the object information to the output image, based on any one of such positions.

Alternatively, when a plurality of object detectors 80 detect an object in the overlapping area, the output unit 50 may append the object information to the output image based on the average position. In other words, when two or more object detectors 80 outputs positions for one object, the output unit 50 may append the object information to the output image based on any one of such positions.

When the output image including the visual fields of a plurality of respective image capture devices 12 is generated, the output image may include some areas not covered by any one of the visual fields. For example, the second output image 260 illustrated in FIG. 25 includes a first out-of-field area 264 that are out of range of any of these visual fields.

The output unit 50 may extrapolate the position of an object that is present in the area not covered by any of the visual fields, based on the position and the movement information of the object detected in the images captured in the past. For example, the output unit 50 extrapolates the positions of the object present in the area not covered by any of the visual fields, using a technology such as the optical flow. The output unit 50 may then append the object information to the coordinates corresponding to the estimated position in the output image.

### Seventh Embodiment

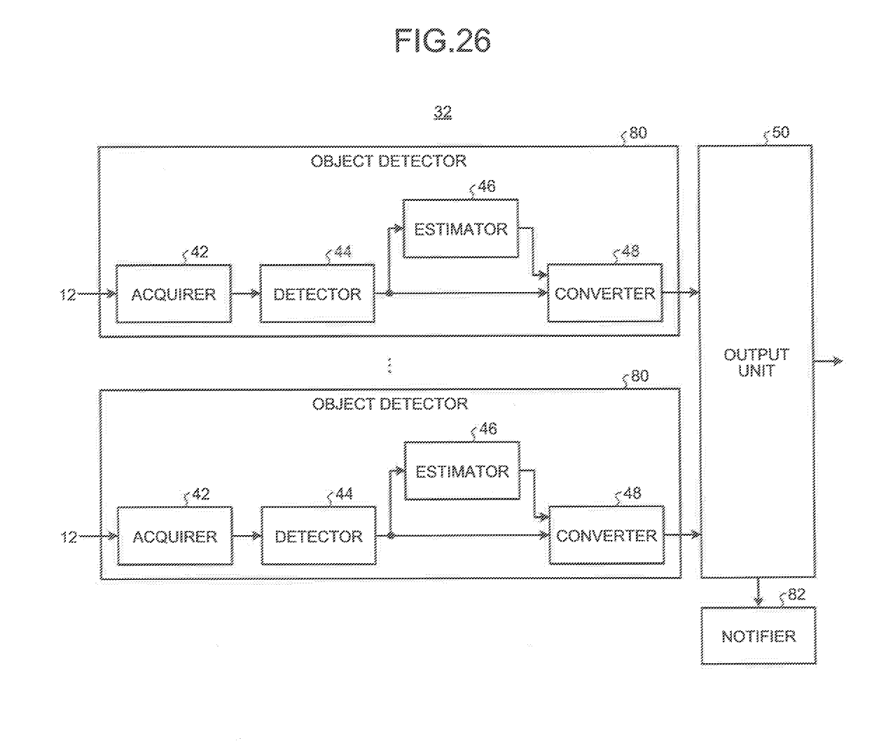

FIG. 26 is a schematic Illustrating a functional configuration of a processing circuit 32 according to a seventh embodiment. The processing circuit 32 according to the seventh embodiment includes a notifier 82 in addition to the configuration according to the sixth embodiment.

A part of the area on the virtual plane of movement is set, in advance, as a designated area in the notifier 82. For example, the notifier 82 may receive a designation of a partial area in the output image as a designated area in accordance with the operation instructed through the mouse or the keyboard.

The notifier 82 acquires the positions of the object detected by the respective object detectors 80, and detects whether the object has moved into the designated area on the virtual plane of movement. If the object has moved into the designated area, the notifier 82 then outputs information indicating that the object has moved into the designated area.

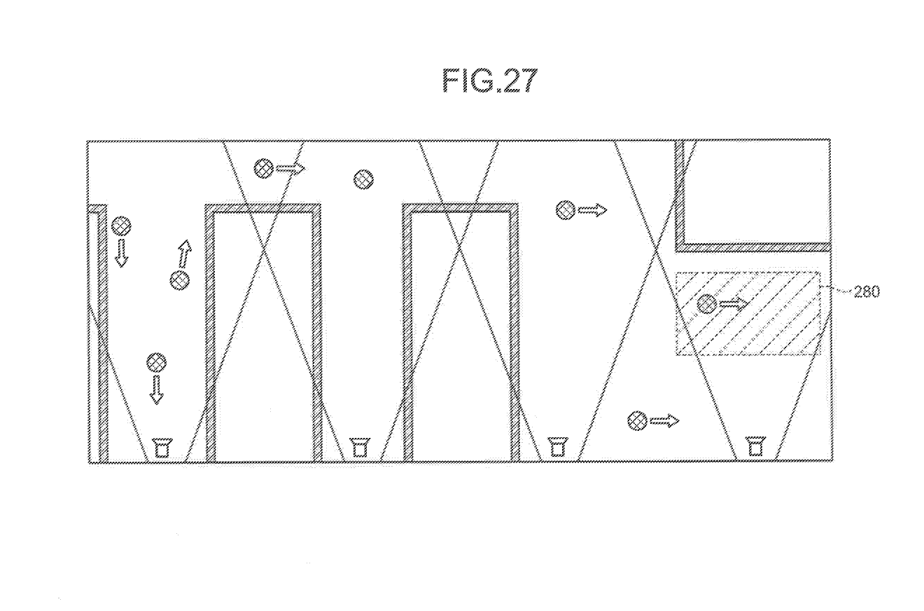

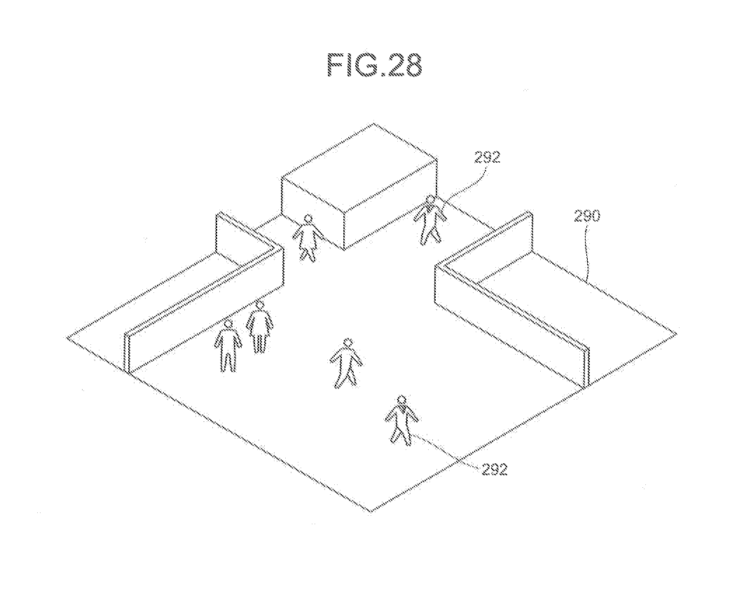

FIG. 27 is a schematic illustrating an example of an output image output from the detection system 10 according to the seventh embodiment. For example, as illustrated in FIG. 27, a first designated area 280 is set, in advance, in the second output image 260 in the notifier 82. If an object has moved into the first designated area 280, the notifier 82 outputs information indicating that the object has moved into the designated area to the external.

For example, when an area where no entry of any object is permitted is specified as a designated area, the notifier 82 may output an alarm using sound or an image. Furthermore, the notifier 82 may turn on an illumination installed in a real apace at a position corresponding to the designated area when an object moves into the designated area, or display predetermined information on a monitor installed in a real space at a position corresponding to the designated area.

### Eighth Embodiment

FIG. 28 is a schematic illustrating an example of an output image output from the detection system 10 according to an eighth embodiment. In the eighth embodiment, the virtual plane of movement may be map information (map information in at quarter view) in which the plane of movement 30 viewed from a predetermined direction other than the vertical direction is represented three dimensionally. The output unit 50 may then display an output image representing such a virtual plane of movement. For example, the output unit 50 may display a third output image 290, as illustrated in FIG. 28.

Furthermore, in the eighth embodiment, the object information may be icons three dimensionally representing the objects viewed from a predetermined angle. The output unit 50 appends such an icon to the corresponding position in the output image.

The output unit 50 may also acquire information as to whether each of the objects is moving or not moving, and its moving direction. The output unit 50 may then append an icon capable of identifying whether the object is moving or not moving, and an icon capable of identifying the moving direction of the object to the output image, as the object information. The output unit 50 may also acquire an attribute of each of the objects. The output unit 50 may then append an icon capable of identifying the attribute of the object to the output image.

For example, the output unit 50 may append a person icon 292 to the third output image 290 as the object information, as illustrated in FIG. 28. The person icon 292 indicates the presence of a person. The person icon 232 is also capable of identifying whether the persons is a male or a female. The person icon 292 is also capable of identifying the moving direction of the person, and whether the person is moving or not moving.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a memory; and
processing circuitry configured to:
acquire a captured image of an object on a first plane;
detect a position and a size of the object in the captured image;
determine, based on the position and the size of the object, in the captured image, a mapping relation representing a relation between the position of the object in the captured image and a position of the object in a virtual plane that is the first plane when viewed from a predetermined direction; and
convert the position of the object in the captured image into the position of the object on the virtual plane, based on the mapping relation.

2. The apparatus according to claim 1, wherein
the processing circuitry further configured to:
output an output image representing the virtual plane and appended with object information indicating presence of the object, and
the processing circuitry appends the object information to coordinates cox-responding to the position of the object in the output image.

3. The apparatus according to claim 2, wherein the processing circuitry determines the mapping relation based on detection results of a plurality of objects at different positions in the captured image.

4. The apparatus according to claim 3, wherein the processing circuitry determines a relation between the size of the object and the position of the object in the captured image as the mapping relation.

5. The apparatus according to claim 4, wherein the processing circuitry determines a regression equation including the size of the object as an objective variable, and determines the position of the object in the captured image as an explanatory variable.

6. The information processing apparatus according to claim 5, wherein
the processing circuitry;
calculates an estimated size of the object, based on the regression equation and the position of the object included in the captured image;
calculates a distance from an image capture device having generated the captured image to the object, based on the estimated size of the object;
calculates an angle of the object with respect to an optical axis of the capture device; and
calculates the position of the object on the virtual plane based on the angle and the distance.

7. The apparatus according to claim 4, wherein
the processing circuitry;
detects whether the object is in each of different detecting positions;
acquires the mapping relation representing a relation between the size of the object and the position of the object in the captured image from the determiner; and
changes the size of the object to be detected by the searcher to a size determined based on the detection position and the mapping relation.

8. The apparatus according to claim 7, wherein
the processing circuitry determines, based on detection results of a plurality of objects, a present area estimated to include the objects in the captured image,
the processing circuitry;
acquires the present area from the determiner in advance; and
sets the present area as a range to which a detection process is executed to the searcher, and
the processing circuitry scans detection positions within the present area.

9. The apparatus according to claim 2, wherein
the processing circuitry determines the mapping relation for each of a plurality of divided areas into which the captured image is divided, and
the processing circuitry identifies a divided area including the object, and calculates the position of the object on the virtual plane based on the mapping relation determined for the identified divided area.

10. The apparatus according to claim 2, wherein the processing circuitry appends an icon to the output image as the object information.

11. The apparatus according to claim 2, wherein
the processing circuitry;
counts number of objects in each of a plurality of detection areas into which the virtual plane is divided, and
appends information representing the number of objects to coordinates of the corresponding detection area in the output image, as the object information.

12. The apparatus according to claim 11, wherein the information representing the number of objects includes a number, a color, a luminance, an icon, a transparency, a character, or a symbol.

13. The apparatus according to claim 2, wherein
the processing circuitry:
determines a position of an object that is present in an area outside of a visual field based on a position and movement information of an object detected in a captured image of past, and
appends the object information to the determined position.

14. The apparatus according to claim 2, wherein the processing circuitry:
acquires captured a plurality of images captured from viewpoints that are different from one another, and
outputs a plurality of positions of an object in a common virtual plane, and
appends the object information to coordinates corresponding to the respective positions of the object in the output image.

15. The apparatus according to claim 2, wherein the processing circuitry further configured to:
output, when the object moves into a designated area on the virtual plane, information representing that the object has moved into the designated area.

16. The apparatus according to claim 2, wherein the virtual plane is map information representing the first plane when viewed from a vertical direction two dimensionally.

17. The apparatus according to claim 2, wherein
the virtual plane is map information representing the first plane when viewed from a predetermined angle other than the vertical direction three dimensionally, and
the object information is an icon three dimensionally representing the object when viewed from the predetermined angle.

18. A detection system comprising:
the information processing apparatus according to claim 2;
an input device chat inputs the captured image; and
a display device that displays the output image.

19. The detection system according to claim 18, further comprising an image capture device that generates the captured image.

20. An information processing method performed in an information processing apparatus, the method comprising:
acquiring, by processing circuitry, a captured image of an object on a first plane;
detecting, by the processing circuitry, a position and a size of the object in the captured image;
determining, by the processing circuitry, based on the position and the size of the object in the captured image, a mapping relation representing a relation between the position of the object in the captured image and a position of the object in a virtual plane that is the first plane when viewed from a predetermined direction; and
converting, by the processing circuitry, the position of the object in the captured image into the position of the object on the virtual plane, based on the mapping relation.
